(19) United States
(12) Patent Application Publication
(10) Pub. No.: US 2009/0237374 A1
(43) Pub. Date: Sep. 24, 2009

(54) TRANSPARENT PRESSURE SENSOR AND METHOD FOR USING

(75) Inventors: Hao Li, Chandler, AZ (US); Papu Maniar, Mesa, AZ (US); Yi Wei, Chandler, AZ (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 12/052,365

(22) Filed: Mar. 20, 2008

(51) Int. Cl. G06F 3/045; B32B 5/16

(52) U.S. Cl. 345/174; 428/323

(57) ABSTRACT

A material (100) includes a transparent matrix (102) comprising at least one polymer material, and a plurality of transparent conducting particles (104) dispersed in the transparent matrix (102). The material (100) may be disposed between an array of conductive intersects to form a transparent piezoresistive sensor (300, 602). A controller (606) is coupled to the transparent piezoresistive sensor (300, 602) for sensing (702, 802, 902) a change in resistance when pressure is applied to the transparent matrix. One or more pressure levels and/or one or more locations may be sensed (704, 804, 904) to enable a function.

### FIELD

The present invention generally relates to electronic devices and more particularly to a transparent pressure sensor.

### BACKGROUND

The market for electronic devices having displays, for example, televisions, computer monitors, cell phones, personal digital assistants (PDA's), digital cameras, and music playback devices (MP3), is very competitive. Manufactures are constantly improving their product with each model in an attempt to cut costs and production requirements.

In many electronic devices, such as portable communication devices, touch panel displays (touch screen) present information to a user and also receive input from the user. A touch screen offers intuitive inputting for a computer or other data processing devices. It is especially useful in portable communication devices where other input devices, such as a keyboard and a mouse, are not easily available.

There are many different types of touch sensing technologies, including capacitive, resistive, infrared, and surface acoustic wave. All of these technologies sense the position of touches on a screen. However, they do not respond to the pressure that is applied against the touch screen.

It has been previously been disclosed in U.S. Pat. No. 6,492,979 to use a combination of capacitive touch screen and force sensors to prevent false touch. This disclosure however complicates the sensor interface and can not sense different touch forces at the same time. It has also been proposed in U.S. Pat. No. 7,196,694 to use force sensors at the peripherals of the touch screen to determine the position of a touch. This however does not offer a capability of multi-touch. It has also been proposed in US patent publication 2007/0229464 to use a capacitive force sensor array, overlaying a display to form a touch screen. This approach offers multi-touch capability; however, a capacitive pressure sensor has limited spatial resolution. It also is subject to environmental interferences such as EMI and capacitive coupling of fingers and other input devices.

Accordingly, it is desirable to provide a transparent pressure sensor to form a force sensing touch screen. Furthermore, other desirable features and characteristics of the present invention will become apparent from the subsequent detailed description and the appended claims, taken in conjunction with the accompanying drawings and this background.

### BRIEF DESCRIPTION OF THE DRAWINGS

Embodiments of the present invention will hereinafter be described in conjunction with the following drawing figures, wherein like numerals denote like elements, and

FIG. 1 is a cross section of a transparent piezoresistive material in accordance with the exemplary embodiment;

FIG. 2 is a cross section of the transparent piezoresistive material of FIG. 1 that is subjected to pressure;

FIG. 3 is a partial cross section of an intersection of conductive traces of the exemplary embodiment including a transparent piezoresistive layer;

FIG. 4 is a perspective view of the exemplary embodiment of FIG. 3;

FIG. 5 is a partial cross section of an intersection of conductive traces of another exemplary embodiment including a patterned transparent piezoresistive layer; and

FIG. 6 is as block diagram of a device incorporating the exemplary embodiments;

FIG. 7 is a flow chart of a first exemplary method of use of the exemplary embodiments;

FIG. 8 is a flow chart of a second exemplary method of use of the exemplary embodiments; and

FIG. 9 is a flow chart of a third exemplary method of use of the exemplary embodiments.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

A transparent pressure sensing material includes a transparent matrix including, for example, at least one polymer material, and a plurality of transparent conducting particles dispersed in the transparent matrix. The polymer material may comprise, for example, phenoxy resin, polyester, silicone rubber, or polyimide. The transparent conducting particles may be, for example, indium tin oxide, zinc oxide, or tin oxide. The transparent conducting particles dispersed in the transparent matrix preferably have a dimension less than the wavelength of light in the visible range to minimize light scattering.

A transparent pressure sensor is formed by applying transparent conducting electrodes to the opposite surfaces of the piezoresistive material. When pressure is applied against the sensor, the resistance across the electrodes decreases and is measured through the electrodes. This change in resistance is then converted into pressure changes.

This piezoresistive material may be used in many types of devices, including touch screens, and any other force sensing applications which require underneath features being visible so the transparent nature of the force sensing material is desired. One example would be applications in polishing process where a transparent force sensing device can be applied to a transparent wafer. In this fashion, not only the pressure can be mapped across the wafer, the contact points between the wafer and the polishing pad can be directly observed.

There are many different types of touch sensing technologies, including capacitive, resistive, infrared, and surface acoustic wave. All of these technologies sense the position of touches on a screen. However, it is desirable to have a touch sensing device that not only senses the position of the touch, but also the force applied to the touch screen. Force sensing provides an extra dimension of freedom in inputting: it can simplify the input process by enabling different combinations of positions and forces on a touch screen. It also offers the possibility of discriminating against false touches by setting different force thresholds before a touch can register. An additional advantage is that force sensing is not limited to only finger touch as in the case of capacitive sensing, it also accept input from almost all other devices including stylus, glove, and credit cards. It is also more tolerant to environmental noises such as EMI and dirt/oil on surface.

The touch screen sensor described herein is formed on a transparent substrate, comprising glass or a polymer, for example. A layer of first patterned conductive traces are deposited over the substrate. A layer of second patterned conductive traces are deposited over the layer of first patterned conductive traces to form an array of addressable intersects (pixels). Scan and read signals are sent and received through tab connectors attached to each of the first and second patterned conductive traces. A piezoresitive material is deposited between the first and second patterned conductive traces at the intersect of each first and second conductive traces. The piezoresistive material may be a continuous layer or may be patterned to be positioned only at the intersects and preferably has a transparent elastomeric matrix, such as polyester, phenoxy resin, or silicone rubber. Transparent conductive or semiconductive particles such as indium tin oxide, zinc oxide, or tin oxide dispersed within the matrix. The dimensions of these particles are smaller than the wavelength of visible light so that scattering of light passing through the matrix is minimum.

The resistance at each intersect is controlled by the pressure applied at that intersect. Current flows through the piezoresistive material and through the particles, either directly when the particles are in contact with each other, or by tunneling when the particles are separated by a very small distance. When pressure is applied to the material, it deforms and shortens the tunneling distance between the particles as well as the conductive path of current flow, thus lowering the resistance.

By scanning the rows and columns of the conductive traces and mapping the resistance of the piezoresistive materials at each intersection, a corresponding pressure map of the touch screen may be obtained. This map provides both the position and the force of the corresponding touch. The touch screen sensor is also multitouch capable. When multiple fingers or objects are placed on the screen, each individual position and force can be distinguished, thus enabling greater freedom of inputting.

Referring to FIG. 1, a transparent matrix 100 includes a material 102 including at least one polymer. For example, the material 102 may comprise a transparent elastomeric matrix such as polyester, phenoxy resin, polyimide, or silicone rubber. Transparent conductive or semiconductive particles 104 such as indium tin oxide, zinc oxide, or tin oxide dispersed within the material 102.

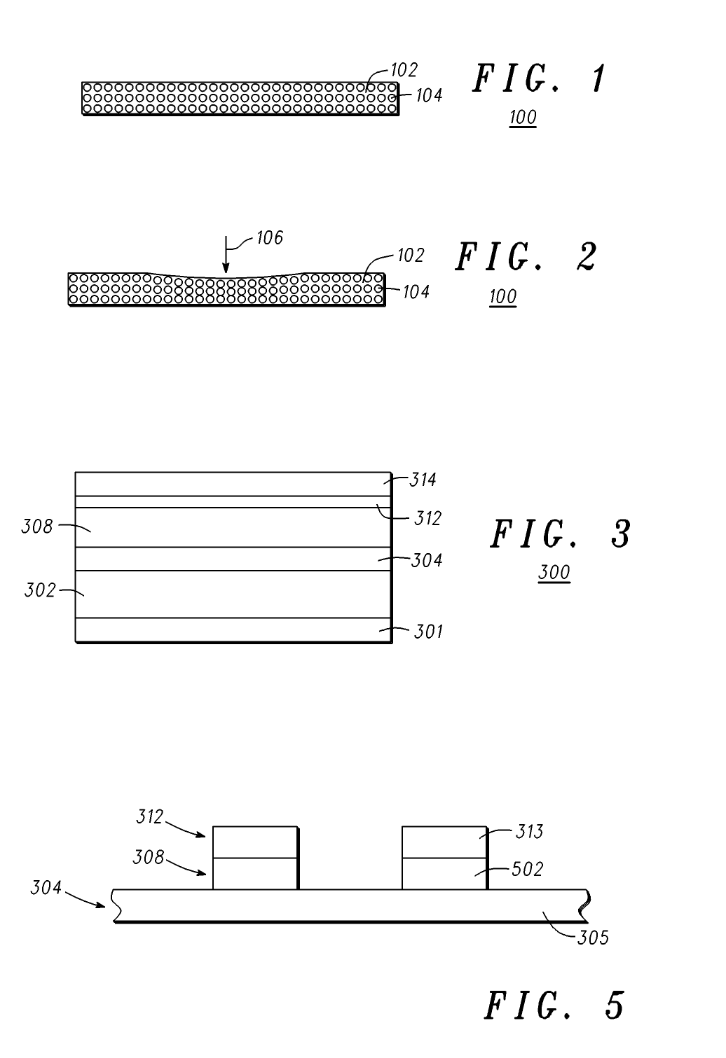

This transparent matrix 100 may be used as a pressure sensor in many electronic applications. When pressure is applied to the transparent matrix 100 in a direction 106 (FIG. 2), the matrix 100 is compressed, reducing the distance between adjacent particles 104 as well as the conductive path between electrodes (not shown), thereby lowering the resistance. Current flows through the material 102 and through the particles 104, either directly through the particles 104 when the particles 104 are in contact with each other, or by tunneling through the material 102 when the particles 104 are separated by a very small distance.

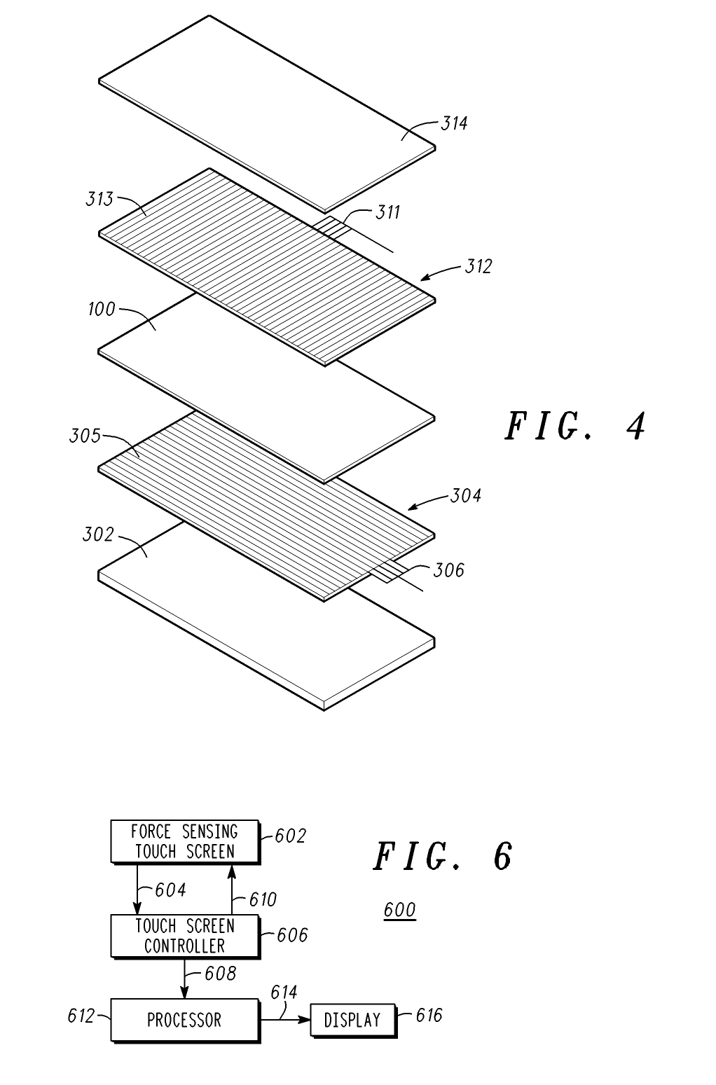

Referring to FIGS. 3 and 4, a transparent pressure sensor 300 includes a transparent substrate 302 preferably is a rigid material of, for example, glass or a polymer, but may be a flexible material. A patterned layer 304 of transparent conductive traces 305 is deposited on the substrate 302. The traces 305 are preferably aligned in a first direction and have a pitch of 0.05-10 mm, (preferably 1.0 mm), a width less than the pitch but larger than 0.001 mm, a thickness of 1.0-1000 nm, (preferably 80 nm). The transparent traces 305 may be a transparent conductive oxide, for example, indium tin oxide, zinc oxide, and tin oxide. A tab 306 is electrically coupled to each trace for providing connection to other circuitry as is known in the industry.

Transparent matrix 100 is disposed on the traces 305 as a layer or in a predetermined pattern. The transparent material 102 preferably is a transparent elastomeric matrix such as polyester, phenoxy resin, or silicone rubber. Transparent conductive or semiconductive particles 104 such as indium tin oxide, zinc oxide, or tin oxide dispersed within the matrix 110 as discussed above.

A patterned layer 312 of transparent conductive traces 313 is deposited over the layer 308 of the transparent matrix 100. The placement of the transparent conductive traces 313 creates a plurality of intersections, each including one of the transparent conductive traces 313, the transparent matrix 100 and the transparent conductive traces 305 (FIG. 4). The layer 308 may be patterned to form a plurality of islands 502, with each island formed between an intersect of the transparent conductive traces 305 and 313 (FIG. 5). An optional layer 314 of a transparent protective material, such as glass or a polymer, is disposed over the patterned layer 312.

When pressure is applied to the transparent matrix 100 by applying pressure to the layer 314, the matrix 100 is compressed, reducing the distance between adjacent particles 104 as well as the conductive path, thereby lowering the resistance between conductive traces 305 and 313. Current flows through the matrix 100 and through the particles 104, either directly when the particles 104 are in contact with each other, or by tunneling through the matrix 100 when the particles 104 are separated by a very small distance.

By being able to sense this change in resistance due to pressure being applied to the transparent pressure sensor 300, the selection of modes, or functions, may be accomplished. This selection of modes by applying pressure may be accomplished alone or in combination with a conventional imaging device 301, for example a liquid crystal display. Those skilled in the art will appreciate that other types of imaging devices 301 may be utilized as exemplary embodiments, including, for example, transmissive, reflective or transflective liquid crystal displays, cathode ray tubes, micromirror arrays, and printed panels.

While the transparent pressure device described herein may be used in electronic devices in general, a block diagram of a force imaging system 600 as an example using the transparent pressure sensor is depicted in FIG. 6. A touch screen controller 606 provides drive signals 610 to a force sensing touch screen 602, and a sense signal 604 is provided from the force sensing touch screen 602 to the touch screen controller 606, which periodically provides a signal 608 of the distribution of pressure to a processor 612. The processor interprets the controller signal 608, determines a function in response thereto, and provides a display signal 614 to a display 616 (display 103 in FIG. 3).

A first exemplary embodiment, shown in FIG. 7, includes determining 702 if pressure applied to a specific location on the pressure sensor of an electronic device exceeds a threshold and enabling 704 a function of the electronic device if the threshold is exceeded. This prevents inadvertent light pressure, such as imparted by touching clothing, from enabling the function. For example, in phone dialing mode, when the finger lightly touches on a key shown in the display, the system will sense the touch, but only when the touch force exceeds a preset value, and the system will trigger the dialing action.

In a second exemplary embodiment (FIG. 8), a determination 802 is made if pressure applied to the pressure sensor exceeds a first or a second threshold, and enabling 804 a first function if the pressure exceeds only the first threshold and a second function if the pressure exceeds the first and second thresholds. For example, when the force exceeds first threshold, one can select and move an object across the screen and drop the object when the force exceeds second threshold (drag and drop). Another example is, in the game mode (car race game), one can drive the car at different speed by controlling the press force at different threshold values.

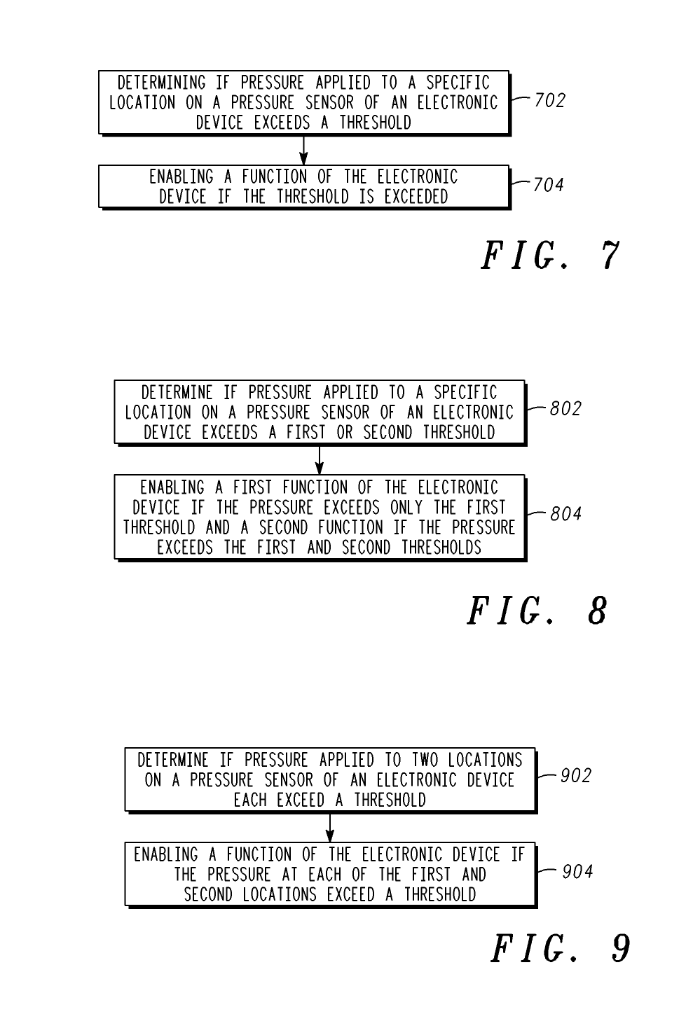

In a third exemplary embodiment (FIG. 9), a determination 902 is made of whether pressure is applied beyond a threshold at two different locations, thereby reducing the resistance at two regions of intersections, and enabling 904 a function if the pressure at both of the two regions exceed the threshold. For example, two different objects, such as pictures and windows, can be selected simultaneously for alignments or operations. This example may be expanded by applying different levels of pressure at the two locations to select additional functions.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A material comprising:
a transparent matrix; and
a plurality of transparent conducting particles dispersed in the transparent matrix.

2. The material of claim 1 wherein the transparent conducting particles dispersed in the transparent matrix have a dimension less than the wavelength of light in the visible range.

3. The material of claim 1 wherein the wavelength of the transparent conducting particles are selected to minimize the scattering effect of radiation passing through the transparent composite material.

4. The material of claim 1 wherein the transparent matrix changes resistance when pressure is applied thereto.

5. The material of claim 1 wherein the transparent matrix comprises a transparent elastomeric matrix selected from one of the materials consisting of polyester, polyimide, latex, phenoxy resin, and silicone rubber.

6. The material of claim 1 wherein the transparent conducting particles comprise one of the materials selected from one of the materials consisting of indium tin oxide, zinc oxide, and tin oxide.

7. The material of claim 1 wherein the material comprises a transparent pressure sensor having transparent electrodes on opposed surfaces of the material.

8. A device comprising:
a transparent matrix comprising at least one polymer material;
a plurality of transparent conducting particles dispersed in the transparent matrix; and
a controller coupled to the transparent matrix for sensing a change in resistance when pressure is applied to the transparent matrix.

9. The device of claim 8 further comprising a touch screen comprising a display coupled to the controller and disposed adjacent the transparent matrix in a line of sight.

10. The device of claim 8 wherein the transparent matrix provides a varying resistance based on the amount of pressure applied thereto.

11. The device of claim 8 wherein the transparent matrix comprises a patterned layer.

12. The device of claim 8 wherein the transparent matrix provides a first change in resistance to a first pressure at a first location and a second change in resistance to a second pressure at second location.

13. The device of claim 8 further comprising first and second layers of a conductor material on opposed surfaces of the transparent matrix, at least one of the first and second layers being patterned, the first and second layers being coupled to the controller for selectively measuring the resistance at one of a plurality of pixels.

14. A method of selecting one of a plurality of modes of an electronic device having a pressure sensor including a first and a second plurality of transparent conductive traces defining unique intersections, wherein the first and a second plurality of transparent conductive traces are coupled to circuitry within the electronic device, comprising:
detecting a change in resistance within a transparent piezoresistive material disposed between one of the first plurality of transparent conductive traces and one of the second plurality of transparent conductive traces at a first intersection; and
selecting a mode based on the sensing of the change in resistance.

15. The method of claim 14 wherein the selecting step comprises:
selecting one of a plurality of modes based on the amount of change in resistance sensed.

16. The method of claim 14 wherein the detecting step comprises detecting a change in resistance within a transparent piezoresistive material disposed between the one of, or another of, the first plurality of transparent conductive traces and one of the second plurality of transparent conductive traces at a second intersection.

17. The method of claim 14 wherein the detecting step comprises:
detecting a change in resistance within the transparent piezoresistive material disposed between another combination of one of the first and one of the second plurality of transparent conductive traces at a second intersection; and
wherein the sensing step comprises:
selecting a mode based on the sensing of the change in resistance at the first and second intersections.
